(19) United States
(12) Patent Application Publication
(10) Pub. No.: US 2021/0246520 A1
(43) Pub. Date: Aug. 12, 2021

(54) METHOD FOR MANUFACTURING SHOE MATERIAL COMPRISING LEATHER AND CLOTH AND SHOE MATERIAL MADE THEREFROM

(71) Applicant: FENG TAY ENTERPRISES CO., LTD., TOU LIO (TW)

(72) Inventor: I-CHUN HUNG, TOU LIO (TW)

(73) Assignee: FENG TAY ENTERPRISES CO., LTD., TOU LIO (TW)

(21) Appl. No.: 17/118,243

(22) Filed: Dec. 10, 2020

(30) Foreign Application Priority Data
Feb. 11, 2020 (TW) 109104198

(51) Int. Cl. C14B 1/02; B32B 7/12; B32B 38/00; B32B 9/02; B32B 27/40; B32B 3/30; B32B 37/12; B32B 27/28

(52) U.S. Cl. CPC C14B 1/02; B32B 7/12; B32B 38/0004; B32B 9/025; B32B 27/40; B32B 3/30; B32B 2037/1215; B32B 27/283; B32B 2038/008; B32B 2317/08; B32B 2305/18; B32B 2375/00; B32B 2437/02; B32B 37/1207

(57) ABSTRACT

The invention provides a method for manufacturing shoe material containing leather and cloth and a shoe material made therefrom. The method includes the steps of: a) material preparation; b) leather treatment; c) gluing; d) TPU (thermoplastic polyurethane) placement; and e) hot pressing. This saves time compared to the sewing process. The shoe material includes a cloth, a leather, a first hot-melt adhesive layer selectively provided on said leather or said cloth, and a TPU film having a second hot-melt adhesive layer covered on the leather and the cloth with the second hot-melt adhesive layer in contact with the leather and the cloth. In this way, the problem of excessive adhesive is avoided.

### BACKGROUND OF THE INVENTION

### 1. Field of the Invention

The present invention relates to shoe material technology and more particularly, to a method for manufacturing a shoe material comprising leather and cloth and a shoe material made therefrom.

### 2. Description of the Related Art

With the advance of the times, people's views on shoes have gradually changed from just the device that people need to wear to one of the fashion accessories. Therefore, the demand of shoe manufacturers for shoe materials has also begun to produce diversified and composite development. For example, in traditional cognition, sports shoes mostly use cloth as the main shoe-making material, while traditional casual shoes mostly use leather as the main material. Today, there are applications that use shoe materials that combine leather with cloth, or artificial leather with cloth, to make shoe products.

However, shoe materials that combine leather with cloth, or artificial leather with cloth, are mainly combined by sewing. This production method is time-consuming and the surface of the finished product will show stitching. Furthermore, you can also use the thermal bonding process, which applies an adhesive on the cloth and then heat presses with the leather. However, although this method is more time-saving than the sewing method, in addition to selecting adhesives according to different types of cloth, in order to ensure that the leather and the cloth can be closely bonded, the gluing area on the cloth must be larger than the bonding area of the cloth and the leather. The gluing area can be seen on the surface of the finished product, which causes the excessive adhesive problem to deteriorate the appearance of the finished product.

### SUMMARY OF THE INVENTION

It is the main object of the present invention to provide a method for manufacturing a shoe material comprising leather and cloth and a shoe material made therefrom, wherein the shoe material manufacturing method can save time compared with the sewing process, and the manufactured shoe material can avoid the problem of excessive adhesive.

To achieve the objects of the present invention, a method for manufacturing a shoe material comprising leather and cloth comprises the steps of: a) material preparation: to prepare a cloth and a leather; b) leather treatment: the leather having a front surface and a back surface; to skive a part of the front surface of the leather to form a junction area; c) gluing: to set a first hot-melt adhesive layer on the back surface of the leather or the cloth; d) TPU (thermoplastic polyurethane) film placement: to prepare a TPU film having a second hot-melt adhesive layer and then to cover the TPU film on the junction area and the cloth so that the second hot-melt adhesive layer contacts the junction area and the cloth to form a shoe material; and e) hot pressing: to place the shoe material on a jig and to cover a silicone pressure pad on the shoe material, and then to put the shoe material with the jig and the silicone pressure pad in a hot press machine for hot pressing. The method in the invention can save the shoe material production time compared to the sewing process.

It should be noted that in the skiving treatment of the step of leather treatment, the thickness of the junction area of the leather is not less than 0.4 mm. This is a consideration of the strength of the leather after bonding.

Preferably, the method further comprises a sub step, adding treatment agent, after skive a part of the front surface of the leather, of adding a treatment agent to the back surface of the leather and the junction area after performing the skiving treatment in the step of leather treatment. Adding treatment agent step allows the treatment agent to fill the area being skived, so that the rough surface after skiving is coated with the treatment agent to facilitate the subsequent bonding step. In the present invention, suitable treatment agents include: NP99, NP200, 71KMN, 111GN, 122 KN, and UE-31, produced by NAN PAO RESINS CHEMICAL CO., LTD.

Preferably, the method further comprises a sub step, leather splitting, to thin the thickness of the back surface of the leather before performing the skiving treatment in the step of leather treatment. Leather splitting allows the thickness of the leather to be not less than 0.8 mm, so that it can satisfy the need in the subsequent processing processes.

Preferably, in the step e), the thickness of the silicone pressure pad is about 8 mm. This is to ensure the effect of thermal pressing bonding.

In the step e), the hot-pressing conditions of the hot press machine are a pressing temperature of 150-170 degrees Celsius, a pressing pressure of 25-30 kg/cm2, and a pressing time of 30-50 seconds. These conditions ensure the thermal pressing effect of the shoe material.

Preferably, the method further comprises step f) cold pressing: to put the shoe material into a cold press machine for pressing and setting after the step e) hot pressing. In the step f), the cold-pressing conditions of the cold press machine are a pressing pressure of 15-20 kg/cm2 and a pressing time of 15-30 seconds.

The invention further provides a shoe material comprising leather and cloth. The shoe material comprises a cloth, a leather, a first hot-melt adhesive layer selectively provided on the leather or the cloth and in contact with the leather and the cloth, and a TPU film having a second hot-melt adhesive layer. The TPU film is covered on the leather and the cloth with the second hot-melt adhesive layer in contact with the leather and the cloth. In this way, the effect of using the first hot-melt adhesive layer and the second hot-melt adhesive layer as bonding materials can avoid the problem of excessive adhesive.

It is worth mentioning that the leather comprises a front surface and a back surface, and the front surface of the leather is partially skived to form a junction area. Furthermore, the TPU film is covered on the junction area and the cloth with the second hot-melt adhesive layer in contact with the junction area and the cloth. In this way, the structural strength of the shoe material can be strengthened, and it is less likely to cause delamination.

### BRIEF DESCRIPTION OF THE DRAWINGS

FIG. 1 is a flow block diagram of a method for manufacturing a shoe material comprising leather and cloth in accordance with a first embodiment of the present invention.

FIG. 2 is a schematic sectional view of a shoe material comprising leather and cloth in accordance with a second embodiment of the present invention.

FIG. 3 is a schematic sectional view of a shoe material comprising leather and cloth in accordance with a third embodiment of the present invention.

### DETAILED DESCRIPTION OF THE INVENTION

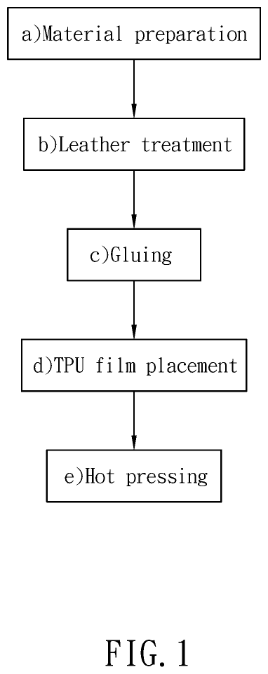

Referring to FIG. 1 and FIG. 3, a method for manufacturing a shoe material comprising leather and cloth in accordance with a first embodiment of the present invention comprises the steps of a) material preparation, b) leather treatment, c) gluing, d) TPU (thermoplastic polyurethane) film placement, and e) hot pressing.

The step of a) material preparation is to prepare a cloth 11 and a leather 21.

The step of b) leather treatment is to perform a skiving treatment. The leather has a front surface 211 and a back surface 212. The skiving treatment is to skive a part of the front surface 211 of the leather 21 so as to form a junction area 213. The front surface 211 in this embodiment is the surface to which the leather 21 is to be bonded with other materials. And for this junction area 213, if natural leather is taken as an example, the epidermal layer of the leather 21 is skived to expose the part of the dermal layer. This is to remove the epidermal layer with high oil content, exposing the dermal layer with better joint ability than the epidermal layer, in order to enhance the strength of leather after bonding. It should be noted that in the skiving treatment of the leather treatment step, the thickness of the junction 213 of the leather 21 is not less than 0.4 mm, which is the condition of the leather thickness required for the consideration of the strength of the leather after bonding.

In addition, you can also choose to add a sub step, adding treatment agent, after the skiving treatment, which is to add a treatment agent to the leather 21. The treatment agent can be water-based or oil-based, considering the convenience of application, water-based is preferred.

In addition, it is better to choose to add a sub step, leather splitting, before performing the skiving treatment, which is to thin the back surface 212 of the leather 21. The leather splitting allows the thickness of the leather 21 to be not less than 0.8 mm, which is required for the subsequent processing processes.

The step of c) gluing is to set a first hot-melt adhesive layer 214 on the back surface 212 of the leather 21 or the cloth 11 for bonding the leather 21 and the cloth 11 together.

The step of d) TPU (thermoplastic polyurethane) film placement is to prepare a TPU film 31 having a second hot-melt adhesive layer 311, and then to cover the TPU film 31 on the junction area 213 and the cloth 11 so that the second hot-melt adhesive layer 311 contacts the junction area 213 and the cloth 11 to form a shoe material.

The step of e) hot pressing is to place the shoe material on a jig, and then to cover a pressure pad on the shoe material, and then to put the shoe material with the jig and the pressure pad in a hot press machine for hot pressing so as to complete the shoe material manufacturing process. It is worth mentioning that, in this embodiment, the pressure pad is a silicone pressure pad, and the thickness of the silicone pressure pad is about 8 mm. This is to ensure the effect of thermal compression. The hot-pressing conditions of the hot press machine are a pressing temperature of 150-170 degrees Celsius, a pressing pressure of 25-30 kg/cm2, and a pressing time of 30-50 seconds. These conditions ensure the thermal compression effect of the shoe material. This can save the production time of the shoe material compared to the sewing process.

In addition, in order to ensure the effect of hot pressing, a step f) cold pressing can be optionally included: the shoe material after the step e) hot pressing is put into a cold press machine for pressing and setting. In the step f) cold pressing, the cold-pressing conditions of said cold press machine are a pressing pressure of 15-20 kg/cm2 and a pressing time of 15-30 seconds.

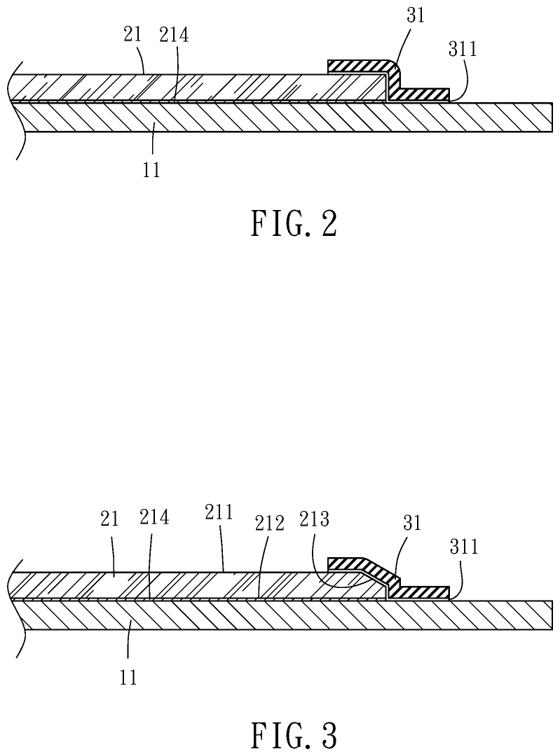

Please refer to FIG. 2, a second embodiment of the present invention provides a shoe material, comprising: a cloth 11, a leather 21, a first hot-melt adhesive layer 214, and a TPU film 31.

The first hot-melt adhesive layer 214 is selectively set on the leather 21 or the cloth 11 and in contact with the leather 21 and the cloth 11.

The TPU film 31 has a second hot-melt adhesive layer 311. The TPU film 31 is covered on the leather 21 and the cloth 11 with the second hot-melt adhesive layer 311 in contact with the leather 21 and the cloth 11.

With this, the effect of using the first hot-melt adhesive layer 214 and the second hot-melt adhesive layer 311 as the bonding material can avoid the problem of excessive adhesive.

It is worth mentioning that, referring to FIG. 3, a third embodiment of the present invention provides a shoe material: the leather 21 has a front surface 211 and a back surface 212. The front surface 211 of the leather 21 is partially skived to form a junction area 213. The TPU film 31 is covered on the junction area 213 and the cloth 11. The second hot-melt adhesive layer 311 contacts the junction area 213 and the cloth 11. In this way, the structural strength of the shoe material can be enhanced.

What is claimed is:

1. A method for manufacturing a shoe material comprising leather and cloth, comprising the steps of:
a) material preparation: to prepare a cloth and a leather that has a front surface and a back surface;
b) leather treatment: to perform a skiving treatment by skiving a part of said front surface of said leather to form a junction area;
c) gluing: to set a first hot-melt adhesive layer on said back surface of said leather or said cloth;
d) TPU (thermoplastic polyurethane) film placement: to prepare a TPU film having a second hot-melt adhesive layer and then to cover said TPU film on said junction area and said cloth so that said second hot-melt adhesive layer contacts said junction area and said cloth to form a shoe material; and
e) hot pressing: to place said shoe material on a jig and to cover a pressure pad on said shoe material, and then to put said shoe material with said jig and said pressure pad in a hot press machine for hot pressing.

2. The method as claimed in claim 1, wherein in said skiving treatment of the step b) leather treatment, the thickness of said junction area of said leather is not less than 0.4 mm.

3. The method as claimed in claim 1, wherein said pressure pad is a silicone pressure pad.

4. The method as claimed in claim 1, further comprising a sub step, adding treatment agent, of adding a treatment agent to said back surface of said leather and said junction area after performing said skiving treatment in the step b) leather treatment.

5. The method as claimed in claim 1, further comprising a sub step, leather splitting, to thin the thickness of said back surface of said leather before performing said skiving treatment in the step b) leather treatment.

6. The method as claimed in claim 5, wherein said leather splitting allows the thickness of said leather to be not less than 0.8 mm.

7. The method as claimed in claim 3, wherein in the step e), the thickness of said silicone pressure pad is about 8 mm.

8. The method as claimed in claim 1, wherein in the step e), the hot-pressing conditions of the hot press machine are a pressing temperature of 150-170 degrees Celsius, a pressing pressure of 25-30 kg/cm2, and a pressing time of 30-50 seconds.

9. The method as claimed in claim 1, further comprising a step f) cold pressing: to put said shoe material into a cold press machine for pressing and setting after the step e) hot pressing.

10. The method as claimed in claim 9, wherein in the step f), the cold-pressing conditions of said cold press machine are a pressing pressure of 15-20 kg/cm2 and a pressing time of 15-30 seconds.

11. A shoe material comprising leather and cloth, comprising:
a cloth;
a leather;
a first hot-melt adhesive layer selectively provided on said leather or said cloth and in contact with said leather and said cloth; and
a TPU film having a second hot-melt adhesive layer, said TPU film being covered on said leather and said cloth, said second hot-melt adhesive layer contacting said leather and said cloth.

12. The shoe material comprising leather and cloth as claimed in claim 11, wherein said leather comprising a front surface; said front surface of said leather being partially skived to form a junction area; said TPU film is covered on said junction area and said cloth with said second hot-melt adhesive layer in contact with said junction area and said cloth.
